(19) United States
(12) Patent Application Publication
(10) Pub. No.: US 2026/0120518 A1
(43) Pub. Date: Apr. 30, 2026

(54) METHOD AND TERMINAL FOR BIOMETRIC ENCODING AND BIOMETRIC IDENTIFICATION

(71) Applicant: IDEMIA PUBLIC SECURITY FRANCE, Courbevoie (FR)

(72) Inventors: Hervé CHABANNE, Courbevoie (FR); Vincent DESPIEGEL, Courbevoie (FR); Damien MONET, Courbevoie (FR)

(73) Assignee: IDEMIA PUBLIC SECURITY FRANCE, Courbevoie (FR)

(21) Appl. No.: 19/268,349

(22) Filed: Jul. 14, 2025

(30) Foreign Application Priority Data
Oct. 30, 2024 (FR) FR2411883

(51) Int. Cl. G06V 40/50; G06V 10/74; G06V 10/82; G06V 30/19; G06V 30/262; G06V 40/12; G06V 40/16; G06V 40/70

(52) U.S. Cl. CPC G06V 40/53; G06V 10/761; G06V 10/82; G06V 30/19093; G06V 30/262; G06V 40/12; G06V 40/16; G06V 40/70

(57) ABSTRACT

A method performed by a data processing device, for generating a biometric encoding matrix, the method taking, as input data, a vector, of an activation map of a neural network applied to at least one image of at least one biometric datum relating to an individual, and supplying, as output datum, an encoding matrix, the method comprising generating, from the activation map, a projection matrix along a reference direction; generating a rotation matrix that leaves the reference direction invariant; and computing a composite matrix from the projection matrix and the rotation matrix, the composite matrix being the encoding matrix.

### TECHNICAL FIELD

The present invention relates to a method and a terminal for generating an encoding matrix for encoding a biometric datum relating to an individual. The invention also relates to a recording medium for recording an encoding matrix for encoding a biometric datum and to a method and a terminal for identifying an individual using the encoding matrix.

### TECHNICAL BACKGROUND

It is common to use protocols for identifying and/or authenticating individuals that are based on comparison of some of their biometric features in order to allow them to access remote services, permit access to information stored in a communal or personal database, check an identity or permit access to a restricted area.

Regardless of whether for authentication or identification, comparison of biometric features is generally carried out not on the raw data directly after they are recorded but on biometric data derived by applying algorithmic processing called encoding. According to section 3.21 of ISO/IEC standard 19794-1:2011 Information technology—Biometric data interchange formats—Part 1: Framework, the derived biometric data form a “biometric template” or “biometric model” that differs from the raw data used to obtain it, and that may be compared with other biometric templates.

Biometric authentication generally consists in comparing a test biometric template acquired for an individual with a single or a very limited number of reference biometric template(s) (1:1). This type of protocol allows a user who wishes to access resources of an information system, such as an operating system, a network, an application, a service, a database or an app, to prove their identity using a biometric feature. Use of an authentication protocol generally requires a prior step of enrolment by way of which a user identifies themselves by sharing a certain amount of information regarding their identity with the entity implementing the protocol.

Carrying out a banking operation remotely, accessing a password database stored on a smartphone, or checking, during a border crossing or during an inspection by law enforcers, the identity of an individual bearing an identity document comprising a secure electronic element in which biometric information is stored are common examples of application of an authentication protocol.

WO 9526013 A1 [MINNESOTA MINING & MFG [US]] Sep. 28, 2024 describes an authentication system that compares a test biometric feature acquired from an individual with a reference biometric feature stored in the system. The system is also configured to detect a variable biometric feature in order to check the liveness of the individual.

Unlike authentication, identification requires comparison of a test biometric template with many other reference biometric templates that are acquired beforehand from multiple individuals (1:N) and generally stored in a database. This type of protocol is used to identify one user among a set of users. The database of reference biometric templates generally requires a prior step of storing biometric templates collected from identified individuals.

Determining, for example within the context of a police investigation, the identity of a person by comparing a dactylogram of their dermatoglyphs, an image of their iris or an image of their face with those in a database of known individuals is a common application for an identification protocol. Another example of application is access to a restricted area for a limited number of individuals.

U.S. Pat. No. 4,109,237 A [HILL ROBERT B] Aug. 22, 1978 describes a method for identifying an individual by comparing the retinal vasculature intercept pattern of their iris with a set of previously stored retinal vasculature intercept patterns from a plurality of individuals.

It is nowadays common for users, when wishing to interact with a remote resource, to authenticate and/or identify themselves using a mobile device, such as a smartphone, tablet or laptop computer, in communication with that resource. However, biometric data, whether in raw or template form, are highly sensitive personal data. It is necessary to ensure their confidentiality, and thereby prevent them from being stolen and/or used for identity theft.

EP 2 813 961 A1 [KONVALINKA IRA [CA]] Dec. 17, 2014 describes a biometric authentication method employing a mobile device coupled to a remote server. The device comprises a biometric sensor and a memory in which a personal reference biometric template specific to its user is stored. At the request of the server, the user acquires a test biometric feature using the biometric sensor of the mobile device. Next, the device generates a test biometric template, compares it with the personal reference biometric template, and transmits a pass or fail signal to the remote server. During this operation, biometric information is confined to the mobile device and is never communicated to the server. Its confidentiality is maintained. In contrast, the remote server has no guarantee as to the real identity of the user of the mobile device.

WO 2017/019972 A1 [VISA INT SERVICE ASS [US]] Feb. 2, 2017 describes a biometric authentication method employing a mobile device paired with an access terminal equipped with a biometric sensor. A personal reference biometric template specific to its user is stored on the mobile device. The mobile device is configured to receive a test biometric template generated by the access terminal, to compare said test biometric template with the personal reference biometric template, and to send the result of the comparison to the access terminal.

The robustness and accuracy of biometric identification and/or authentication protocols depend on the quality of the biometric templates and the digital comparison processing they carry out. As biometric data are data that are likely to be affected by a certain level of noise owing to their nature or the conditions under which they are acquired, biometric template encoding processing is generally based on error correction codes that allow the same biometric template to be extracted from a biometric datum close to an original biometric datum. Biometric template comparison processing can also be based on fuzzy match processing to reduce computation times and/or introduce a certain tolerance to the noise inherent in biometric data, whether compared in encrypted or clear form.

Dodis et al. (2004), “Fuzzy extractors: How to generate strong keys from biometrics and other noisy data.” Advances In Cryptology-EUROCRYPT 2004: International Conference on the Theory and Applications of Cryptographic techniques, Interlaken, Proceedings 23, describes two examples of encoding processing: fuzzy extractors and secure sketches.

Galbraith et al (2019). “Obfuscated fuzzy hamming distance and conjunctions from subset product problems.” Theory of Cryptography Conference describes an example of fuzzy match processing for the Hamming distance.

### SUMMARY OF THE INVENTION

A first drawback of current biometric template encoding and/or biometric template match processing is that it imposes a number of constraints on biometric data and output data. By way of example, in the case of secure sketches, it imposes constraints on the format and/or size of the biometric datum according to the parameters of the correction code. On the other hand, the cryptographic algorithms carried out by current encoding processing are based on cryptographic primitives, each of which has its own input or output data format. When a multiplicity of these primitives are used, it is necessary to ensure that they are interoperable and, in general, to schedule intermediate data transformation operations in order to allow this interoperability.

A second drawback of current identification and/or authentication protocols, whether or not they carry out encoding and/or comparison processing based on error correction codes, is that they require storage of one or more reference biometric templates, sometimes within a database. These biometric templates, even if stored in an encrypted form and/or in secure environments, are not immune to intrusion, alteration and/or fraudulent extraction.

There is therefore a need for a simple and effective biometric encoding solution that reduces the constraints on biometric data and output data while ensuring that said data are confidential and cannot be procured.

In a first aspect of the invention, there is provision for a method, carried out by a data processing device, for generating a biometric encoding matrix, the method taking, as input data, a vector, of an activation map of a neural network applied to at least one image of at least one biometric datum relating to an individual, and supplying, as output datum, an encoding matrix, the method comprising the following steps:
(a) generating, from the activation map, a projection matrix along a reference direction;
(b) generating a rotation matrix that leaves the reference direction invariant;
(c) computing a composite matrix from the projection matrix and the rotation matrix, the composite matrix being the encoding matrix.

According to some embodiments, the rotation matrix is a random matrix.

According to some embodiments, the reference direction is specific to a database for identifying a plurality of individuals and/or to a trusted entity for identifying one or more individuals.

According to some embodiments, the biometric datum relating to the individual can in particular be chosen from among one or more finger and/or palm dactylograms, one or more iris images and/or one or more facial images, or a combination thereof.

According to some embodiments, the method further comprises the following steps:
(e) generating, before the computation step, a random invertible obfuscation matrix specific to a trusted entity for identifying one or more individuals;
(f) computing, after the computation step, an obfuscated encoding matrix composed of the random invertible matrix and the encoding matrix.

In a second aspect of the invention, there is provision for a biometric encoding terminal comprising means for carrying out a method for generating a biometric encoding matrix according to the first aspect of the invention.

In a third aspect of the invention, there is provision for a recording medium on which is recorded an encoding matrix obtained using a method for generating a biometric encoding matrix according to the first aspect of the invention.

According to some embodiments, the encoding matrix is recorded in the form of a two-dimensional code on the recording medium.

According to some embodiments, the encoding medium is a non-transient recording medium readable by a data processing device.

In a fourth aspect of the invention, there is provision for a method for biometrically identifying an individual using an encoding matrix obtained using a generation method according to the first aspect of the invention, the method comprising the following steps:
(a) retrieving an encoding matrix of an individual by reading, preferably contactlessly, a recording medium;
(b) acquiring a biometric datum relating to said individual;
(c) generating, from the biometric datum, an activation map vector by applying a neural network;
(d) generating, from the activation map vector, an encoding vector by applying the encoding matrix;
(e) computing a measure of similarity between the encoding vector and a reference direction;
(f) validating the identification of the individual by comparing the value of the measure of similarity with a previously defined threshold value.

According to some embodiments, the biometric identification method further comprises, after the retrieval step and before the step of generating an encoding vector, a step of computing an encoding matrix by applying a revelation matrix to the obfuscated encoding matrix, said revelation matrix being the inverse matrix of the random invertible obfuscation matrix used to obfuscate said encoding matrix.

According to some embodiments, the measure of similarity is chosen from among a cosine similarity, a Euclidean distance or a Hamming distance.

According to some embodiments, when the measure of similarity is less than or equal to the threshold value, the method returns a specific character string, and when the measure of similarity is greater than the threshold value, the method returns a random character string.

In a fifth aspect of the invention, there is provision for a terminal for biometrically identifying an individual, comprising:
a device for acquiring a biometric datum relating to an individual;
a device for reading a recording medium on which is recorded an encoding matrix obtained using a generation method according to any one of the embodiments of the first aspect of the invention;
a data processing device comprising means for carrying out an identification method according to any one of the embodiments of the fourth aspect of the invention.

### BRIEF DESCRIPTION OF THE DRAWINGS

FIG. 1 is a schematic representation of an area for controlling access comprising a biometric identification terminal and a system of gates.

FIG. 2 is a detailed example of a biometric identification terminal.

FIG. 3 is a flow diagram of a method for generating an encoding matrix according to a first aspect of the invention.

FIG. 4 is a simplified schematic representation of generating an encoding matrix using the method according to the invention.

FIG. 5 is a schematic representation of an encoding terminal in the form of a biometric enrolment machine.

FIG. 6 is a schematic representation of an encoding terminal in the form of a mobile electronic device.

FIG. 7 is a schematic representation of an example of a recording medium for recording an encoding matrix.

FIG. 8 is a flow diagram of an identification method using an encoding matrix.

### DETAILED DESCRIPTION OF THE EMBODIMENTS

Within the context of the present disclosure, embodiments are described in the general context of one or more pieces of hardware or devices capable of executing preloaded instructions such as, for example, computer-executable instructions for executing program modules. The program modules may include one or more routines, programs, objects, variables, commands, scripts, functions, applications, components and/or data structures able to execute particular tasks or implement particular types of abstract data.

Some embodiments may also be implemented in distributed computing environments where tasks are executed by remote data processing devices that are connected by a communication network. In a distributed computing environment, the program modules may reside on local and/or remote computer storage media, including memory storage devices.

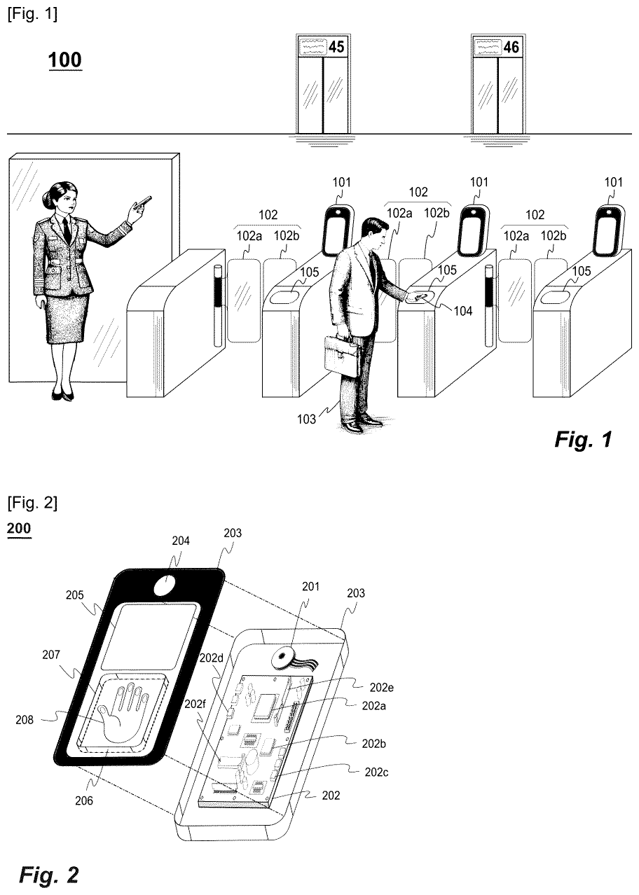

Referring to FIG. 1, an area 100 for controlling access to a site, an event or a territory may comprise a biometric identification terminal 101 and a system 102 of access gates 102a, 102b, the opening or closing, to an individual 103, of which is dependent on the success or failure of a biometric identification of said individual 103 by said biometric identification system 101.

When an individual 101 wishes to access the site, the event or the territory, they must first identify themselves to the biometric identification terminal 101 by submitting an identification request to said terminal 101. According to the example shown in FIG. 1, the request can be submitted through a mobile terminal 104, such as a smartphone, that stores identity data, such as an identifier, a passport and/or an electronic coupon. The biometric identification terminal 101 can then communicate with a contactless reader 105 suited to reading a non-transient memory or a secure element of the mobile terminal 104 in order to access the identity data and/or electronic coupon stored therein. According to another equivalent example, the request can be submitted by placing a physical coupon or a smart card on the reader 105 of the biometric identification terminal 101. The reader 105 may be a contactless reader suited to reading a non-transient memory or a secure element contained in the smart card or the physical coupon, and/or an optical reader suited to reading a code, such as a QR code, displayed on the coupon.

Once the request has been submitted, the biometric identification terminal 101 reads the content of the secure element of the mobile terminal 104 and then acquires a test biometric feature of the individual 103 using an appropriate acquisition device. The biometric feature is generally chosen from among the dermatoglyphs of one or more fingers, palm dermatoglyphs, one or more irises or a face, or a combination thereof. In the example of FIG. 1, the biometric identification terminal 101 is a biometric identification terminal using facial or iris recognition and the acquisition device is a camera.

Once the test biometric feature has been acquired by the acquisition device, the biometric identification terminal 101 identifies the individual 103 on the basis of this biometric feature. If the individual 103is identified, they are permitted to access the site, event or territory. To this end, the biometric identification terminal 101, 200 sends a command signal for opening the gates 102a, 102b to the system 102 of gates 102a, 102b. Otherwise, the user 103 is not identified and is denied access. The gates 102a, 102b of the system 102 of gates 102a, 102b remain closed. The biometric identification terminal 101 can notify the user 103 of the success or failure of the identification using a light signal, a sound signal, a message, or a combination thereof.

A detailed example 200 of a biometric identification terminal 101 is shown in FIG. 2. The biometric identification terminal 200 comprises a physical image acquisition module 201, a physical data processing module 202 and a protective casing 203.

The physical image acquisition module 201 takes the form of a camera suited to acquiring the image of one or more irises or a face. The protective casing 203 comprises a transparent or semi-transparent window 204 to allow image acquisition by the image acquisition module 201, and a display or interactive screen 205. As an alternative or in addition to the physical image acquisition module 201, the biometric identification terminal 200 may comprise a physical module 206 for acquiring a dactylogram of a dermatoglyph of one or more fingers and/or a palm dermatoglyph. On the surface of the protective casing 203 there may be an acquisition area 207 exposing the active surface 208 of said physical acquisition module 206 so that an individual 103 is able to place one or more of their fingers and/or the palm of one of their hands thereon.

The physical image acquisition module 201 and/or the physical dactylogram acquisition module 206 transmit the acquired data to the physical data processing module 202 by means of a connector (not shown). The physical data processing module 202 comprises means for carrying out a biometric identification. It is responsible for automatically executing sequences of arithmetic or logic operations in order to perform tasks or actions. This module, commonly called a computer, may comprise one or more central processing units (CPUs) 202a and/or one or more graphics processors (GPUs) 202b, a physical remote communication module 202c, one or more physical input/output modules 202d for interchanging data with external devices, a transient storage medium 202e such as a random access memory (RAM), a non-transient recording medium 202f and communication busses (not shown) for transferring data between the internal components of the data processing module 202.

The physical data processing module 202 is used to execute one or more program modules comprising instructions that, when the program module or modules are executed, cause the data processing module 202 to carry out a biometric identification. The program module or modules may be written in any, compiled or interpreted, programming language. They may form part of a software solution, i.e. of a collection of executable instructions, of codes, of scripts or the like and/or of databases.

The biometric identification terminal 101, 200 as described above may be used for other purposes, such as permitting access to one or more remote services, permitting access to information stored in a communal or personal database, checking the identity of one or more persons, retrieving login credentials, or retrieving one or more addresses of wallets for digital currency such as a cryptocurrency.

Traditionally, according to biometric identification protocols from the prior art, the biometric identification terminal 101, 200 is configured to generate, according to an encoding scheme, a test biometric template from the test biometric feature acquired by the image or dermatoglyph acquisition device 201, 206 and then to compare said template with one or more reference biometric templates stored in a database. If there is a match between the test biometric template and a reference biometric template, the individual 103 is identified and is permitted to access the site, event or territory. Otherwise, the user 103 is not identified and is denied access.

To guarantee that biometric templates and personal data are secure and confidential, all the data interchanged and stored by the various terminals described above are generally encrypted according to various encryption protocols using secure elements. As noted above, these various encryption protocols impose strong constraints on the size and format of those data. On the other hand, current biometric identification protocols require one or more reference biometric templates to be stored. These biometric templates, even if stored in an encrypted form and/or in secure environments, are not immune to intrusion, alteration and/or fraudulent extraction.

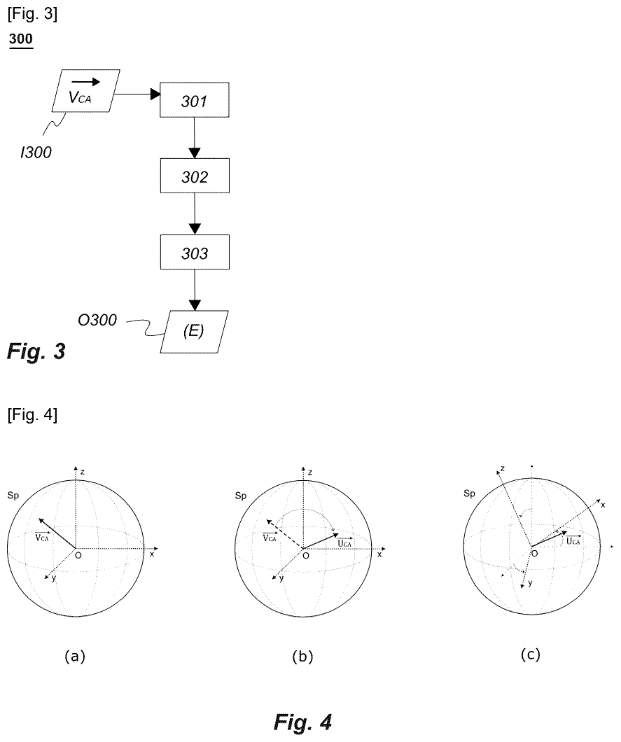

The present invention dispenses with the use of biometric templates and thus with the constraints related to the encryption and storage of biometric data. According to a first aspect of the invention, referring to FIG. 3, there is provision for [R1] a method 300, carried out by a data processing device, for generating a biometric encoding matrix (E), the method taking, as input data I300, a vector \vec{v}_{CA}, of an activation map of a neural network applied to at least one image of at least one biometric datum relating to an individual 103, and supplying, as output datum O300, an encoding matrix (E), the method 300 comprising the following steps:
(a) generating 301, from the activation map, a projection matrix (P) along a reference direction \vec{u}_{DR};
(b) generating 302 a rotation matrix (R) that leaves the reference direction \vec{u}_{DR} invariant;
(c) computing 303 a composite matrix from the projection matrix (P) and the rotation matrix (R), the composite matrix being the encoding matrix (E).

Within the context of the present disclosure, a “biometric datum” means any type of datum representing one or more raw biometric features of an individual without there having been prior processing by way of an encoding algorithm. In particular, a biometric datum, within the meaning of the present disclosure, is not a “biometric template”, in particular as defined in ISO/IEC standard 19794-1:2011 Information technology—Biometric data interchange formats—Part 1: Framework.

An “activation map” or “feature map” of a neural network means a vector \vec{v}_{CA} that represents the results of the application of one or more layers of a neural network to an input image, in this case a biometric datum in the form of an image. Neural networks that can be applied to biometric data images are known from the prior art, for example He, K., Zhang, X., Ren, S., & Sun, J. (2016). Deep residual learning for image recognition. Proceedings of the IEEE conference on computer vision and pattern recognition (pp. 770-778) describes an example of a convolutional neural network, and Dosovitskiy, A. (2020). An image is worth 16×16 words: Transformers for image recognition at scale. arXiv preprint arXiv:2010.11929 describes an example of an attentional neural network.

Depending on the neural network, the size of the activation map can sometimes be quite large and a reduction in magnitude may be advantageous to facilitate use thereof and reduce the computational loads within the context of the method according to the invention. Thus, the method 300 may comprise a preliminary step 301a of generating, from the activation map vector, a reduction matrix (D) vis-à-vis a space of smaller magnitude than the vector of the activation map. Step 303 of computing the encoding matrix (E) is then a composition of said reduction matrix (D), the projection matrix (P) and the rotation matrix (R).

The biometric datum relating to the individual can in particular be chosen from among one or more finger and/or palm dactylograms, one or more iris images and/or one or more facial images, or a combination thereof. Examples of combination may be a concatenation of different biometric data or an average of biometric data of the same type, such as an average of multiple images of the same face.

In step 301, a projection matrix (P) is generated to project the vector \vec{V}_{CA} of the activation map along a reference direction \vec{u}_{DR}. In other words, this involves determination of a matrix (P) such as (P)\vec{v}_{CA}=\vec{U}_{DR}.

According to a purely illustrative example, referring to FIG. 4, an activation map vector \vec{v}_{CA} can be represented in a hypersphere Sp (FIG. 4a). For reasons of simplification, the hypersphere Sp shown is a hypersphere of magnitude 2 and the activation map is a vector \vec{v}_{CA} of magnitude 3.

In this example, in step 301, a projection matrix (P) is determined such that, in a Cartesian frame of reference (O, x, y, z), the vector \vec{v}_{CA}=(vₓ,V_{y},V_{z}) of the activation map is transformed, after application of said projection matrix (P), into another vector representing a reference direction \vec{u}_{DR}=(uₓ,u_{y},u_{z}) in the hypersphere Sp (FIG. 4b). In this example, this then involves determination of a projection matrix (P) of magnitude 3, 3, such as (P)(vₓ,V_{y},V_{z})=(uₓ,u_{y},u_{z}).

In step 302, a rotation matrix (R) is generated that leaves the reference direction \vec{u}_{DR} invariant (FIG. 4c). In other words, this involves determination of a matrix (R) such as (R)\vec{u}_{DR}=\vec{u}_{DR}, namely a rotation matrix (R) whose reference direction, \vec{U}_{DR}, is an eigenvector. There is an infinite number of possible matrices that satisfy this condition. According to preferred embodiments, the rotation matrix (R) is a random matrix.

Referring to the illustrative example of FIG. 4, a rotation matrix (R) is determined so as to leave the reference direction \vec{u}_{DR}=(uₓ,u_{y},u_{z}) invariant. This operation is illustrated by the rotation of the frame of reference (O, x, y, z) of the hypersphere Sp around the direction \vec{U}_{DR}.

In step 303, the projection matrix (P) and the rotation matrix (R) that were determined in the previous steps are multiplied to form a composite encoding matrix (E).

At the end of step 303, only the encoding matrix (E) is retained. The vector \vec{v}_{CA} of the activation map representing the biometric datum has been used only as a means for determining said encoding matrix (E) and is not retained. Thus, no information that is directly linked to the biometric datum, for example its image, or derived directly therefrom, for example a biometric template, is stored.

Since the encoding matrix (E) is computed from the activation map representing the biometric datum specific to an individual, it is specific to each individual. It is different between individuals, and each individual owns their encoding matrix (E). In contrast, the reference direction \vec{u}_{DR} may be common between multiple individuals or specific to each individual, depending on the applications.

Thanks to the composition of the projection matrix (P) and the rotation matrix (R), retrieval of the biometric datum from the encoding matrix (E), for example by way of inversion operations, is impossible. On the other hand, if a third party, by way of a fraudulent act, manages to procure an encoding matrix (E) and a raw biometric datum relating to its owner, then application, by that third party, of this matrix to the raw datum does not allow the activation map that was used for computing it to be retrieved. Such application does not allow them to steal the identity of the owner either, since this operation would supply a different result, in particular a different direction from the reference direction \vec{u}_{DR}.

A noteworthy advantage of the invention is that no biometric reference information specific to each individual is required in order to identify said individuals. It is therefore unnecessary, for example in an enrolment phase, to retrieve, for storage or association with the database of individuals, the biometric data relating to each individual in order to derive reference biometric information therefrom with the aim of identifying said individuals later in an identification phase.

Without being a requirement within the context of the present disclosure, the encoding matrix (E) does not need to be encrypted, since it itself constitutes indirect concealment of the biometric datum, since it does not contain it. It may therefore in particular be recorded without encryption on a non-transient electronic storage medium or printed in the form of a readable code on a physical medium, such as a coupon or a transport or event ticket.

The reference direction \vec{u}_{DR} is the reference from which one or more individuals can be identified. In particular, according to some embodiments, the reference direction \vec{u}_{DR} is specific to a database for identifying a plurality of individuals and/or to a trusted entity for identifying one or more individuals. The individuals in the database and/or associated with the trusted entity can then be identified solely on the basis of this reference direction \vec{u}_{DR}, which is preferably kept secret, by applying the encoding matrix (E) specific to each individual according to a biometric identification method that is described below within the context of the third aspect of the invention. Preferably, the reference direction \vec{u}_{DR} is kept secret and known only to the owner of the identification database and/or the trusted entity.

By way of example, an entity organizing an event such as a concert, a festival, a cultural, theatrical, film or sports performance, or a road, rail or air transport company, can define the same reference direction \vec{u}_{DR} for a database of individuals to be identified who have previously been registered for one or more given events or specific trips. A different reference direction \vec{u}_{DR} can also be chosen for each event or trip. As a particular reference direction \vec{u}_{DR} is then associated with the database of individuals to be identified that is associated with this event or trip, said database has the same direction for all individuals in the database.

According to another example, a trusted entity such as a government administration may define a common but unique reference direction \vec{u}_{DR} DR to identify one or more individuals previously enrolled for, for example, access to different administrative services or a border crossing.

For some applications where a high level of security and/or maintenance of the confidentiality of biometric data is required, for example in the case of absolutely sure certification of an identity, or when the encoding matrix (E) is likely to be publicly exposed, for example on a transport or event ticket, or to be subject to digital threats because of the identity of its bearer, it may be advantageous to add an additional layer of security by way of a concealment or obfuscation operation.

Thus, according to some embodiments, the method 300 further comprises the following steps:
(e) generating 303a, before the computation step 303, a random invertible obfuscation matrix (S) specific to a trusted entity for identifying one or more individuals;
(f) computing 304, after the computation step 303, an obfuscated encoding matrix (O)=(S)(E) composed of the random invertible matrix (S) and the encoding matrix (E).

The application of a random invertible matrix (S) allows the encoding matrix (E) to be further concealed by changing its value. Thus, only the trusted entity that owns the inverse matrix (S⁻¹) of the invertible matrix (S) can access the encoding matrix (E) to identify its owner. On the other hand, a third party who, by way of a fraudulent act, manages to procure an obfuscated encoding matrix (O) would be even less capable of using it for the purpose of identity theft since, when applied, it supplies a completely unusable result without prior knowledge of the inverse matrix (S⁻¹).

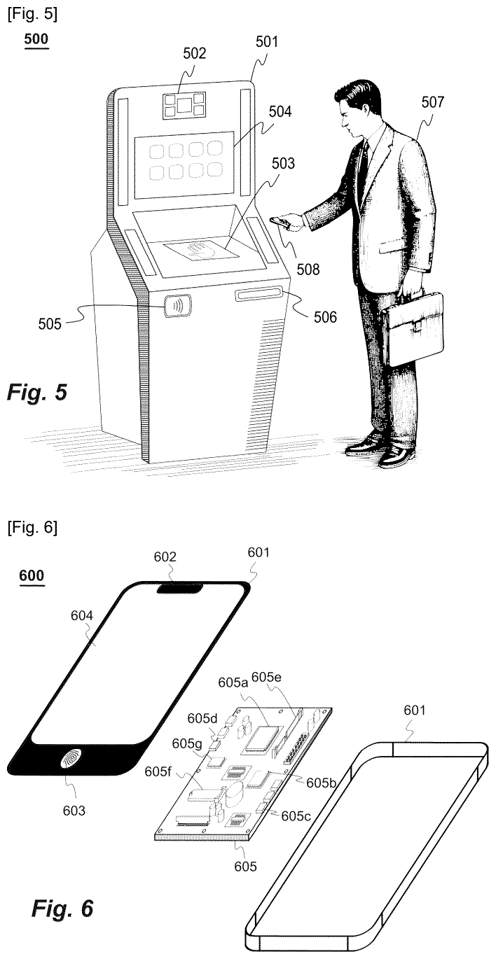

In a second aspect of the invention, referring to FIG. 5 & FIG. 6, there is provision for an encoding terminal 500, 600 comprising means for carrying out a method 300 for generating a biometric encoding matrix according to any one of the embodiments of the first aspect of the invention.

According to a first exemplary embodiment, referring to FIG. 5, the encoding terminal may be a biometric enrolment machine 500 such as a kiosk, in particular for travel or ticketing. The terminal 500 comprises a stand 501, a physical image acquisition module 502 and/or a physical dactylogram acquisition module 503, a physical display module 504, a physical contactless communication module 505 and a physical data processing module (not shown). The terminal may also comprise a module 506 for issuing tickets or coupons.

The stand 501 is in the form of a kiosk whose ergonomics are suited to interaction with an individual 507, such as a traveler or a purchaser, in particular through the physical display module 504, on which instructions intended for the individual 507 can be displayed. The physical image acquisition module 502 takes the form of a camera suited to acquiring the image of one or more irises or a face. The physical image acquisition module 502 and/or the physical dactylogram acquisition module 503 transmit the acquired data to the physical data processing module by means of appropriate connections. The physical data processing module is similar to that shown in FIG. 2. It comprises means for carrying out a method 300 for generating a biometric encoding matrix (E) according to any one of the embodiments of the first aspect of the invention. It is in particular responsible for automatically executing sequences of arithmetic or logic operations in order to perform tasks or actions. This module, commonly referred to as a computer, may comprise one or more central processing units (CPUs) and/or one or more graphics processing units (GPUs), a physical remote communication module, one or more physical input/output modules for interchanging data with external devices, a transient storage medium such as a random access memory (RAM), a non-transient recording medium and communication busses (not shown) for transferring data between the internal components of the data processing module.

The physical data processing module is used to execute one or more program modules comprising instructions that, when the program module or modules are executed, cause the data processing module to carry out a method 300 for generating a biometric encoding matrix (E) according to any one of the embodiments of the first aspect of the invention. The program module or modules may be written in any, compiled or interpreted, programming language. They may form part of a software solution, i.e. of a collection of executable instructions, of codes, of scripts or the like and/or of databases.

The physical contactless communication module 505 allows information to be exchanged between the encoding terminal 500 and a non-transient memory and/or a secure element of a smart card or of a mobile electronic terminal 508, such as a smartphone. It can be used in particular to transfer the data of an encoding matrix (E) generated by the encoding terminal 500 to the non-transient memory and/or a secure element of the smart card or of the mobile electronic terminal 508 in order to record said encoding matrix in said smart card or said mobile electronic terminal 508. The exchange of information between the physical communication module 505 and the smart card or the mobile electronic terminal 508 can be performed according to a near-field and/or short-range communication protocol such as Bluetooth® or WiFi™.

In the context of travel and/or participation in an event, the encoding matrix ((E)) may form part of a coupon or ticket that is also generated by the encoding terminal 500. If in electronic form, the coupon or ticket can be transferred to the non-transient memory and/or a secure element of the smart card or of the mobile electronic terminal 508 by the encoding terminal 500 in order to record said coupon or ticket in said smart card or said mobile electronic terminal 508 through the physical contactless communication module 505. If in physical form, for example in paper form, it can be printed by the encoding terminal 500 via its issuing module 506, for example a printer, for retrieval by the user 507.

According to a second exemplary embodiment, referring to FIG. 6, the encoding terminal may be a mobile electronic device 600, such as a smartphone or mobile biometric acquisition device. The terminal 600 comprises a casing 601, a physical image acquisition module 602 and/or a physical dactylogram acquisition module 603, a physical display module 604 and a physical data processing module 605.

The physical image acquisition module 502 takes the form of a camera suited to acquiring the image of one or more irises or a face. The physical image acquisition module 502 and/or the physical dactylogram acquisition module 503 transmit the acquired data to the physical data processing module by means of appropriate connections. The physical data processing module is similar to that shown in FIG. 2. It comprises means for carrying out a method 300 for generating a biometric encoding matrix (E) according to any one of the embodiments of the first aspect of the invention. It is in particular responsible for automatically executing sequences of arithmetic or logic operations in order to perform tasks or actions. This module, commonly called a computer, may comprise one or more central processing units (CPUs) 605a and/or one or more graphics processors (GPUs) 605b, a physical remote communication module 605c, one or more physical input/output modules 605d for interchanging data with external devices, a transient storage medium 605e such as a random access memory (RAM), a non-transient recording medium 605f and communication busses (not shown) for transferring data between the internal components of the data processing module. It may also comprise a secure element 605g.

The physical data processing module 605 is used to execute one or more program modules comprising instructions that, when the program module or modules are executed, cause the data processing module to carry out a method 300 for generating a biometric encoding matrix (E) according to any one of the embodiments of the first aspect of the invention. The program module or modules may be written in any, compiled or interpreted, programming language. They may form part of a software solution, i.e. of a collection of executable instructions, of codes, of scripts or the like and/or of databases.

Once generated, the encoding matrix (E) can be recorded in a non-transient recording medium 605f or in the secure element 605g of the terminal 600. In the context of travel and/or participation in an event, the encoding matrix (E) may form part of a coupon or an electronic ticket that is generated by the encoding terminal 500 and recorded in its non-transient recording medium 605f or in its secure element 605g.

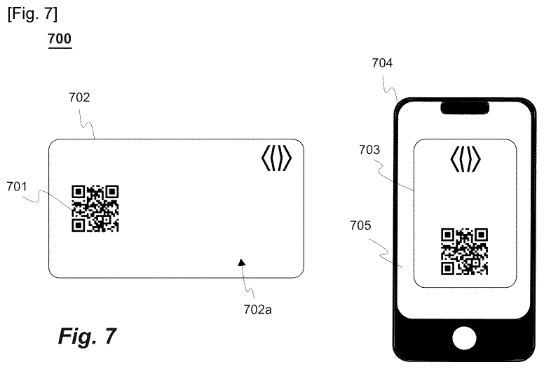

According to a third aspect of the invention, referring to FIG. 6 and FIG. 7, there is provision for a recording medium 605f, 605g, 700 on which is recorded an encoding matrix (E) obtained using a generation method according to any one of the embodiments of the first aspect of the invention.

According to a first embodiment, referring to FIG. 7, the encoding matrix (E) is recorded in the form of a two-dimensional code 701 on the recording medium 700. Said recording medium can then be read by an optical reading device capable of decrypting the content thereof in order to retrieve the encoding matrix (E) therefrom and transmit it to a biometric identification terminal as described below. The medium may, for example, be a medium 702 made of paper or plastic, such as a coupon or transport ticket or a ticket for a sporting or cultural event. The two-dimensional code may, for example, be printed on the surface 702a of the medium 702. The medium may also be a coupon or an electronic ticket 703 that is recorded in a non-transient memory of a mobile electronic device 704, such as a smartphone, and displayable on a screen 705 of said mobile electronic device 704 so as to allow the two-dimensional code it carries to be read.

According to a second embodiment, the recording medium is a non-transient recording medium readable by a data processing device such as a computer. The encoding matrix (E) can then be recorded in the form of a binary machine code. The recording medium may in particular be a non-transient memory 605f, 605g of a mobile electronic device 600, such as a smartphone, whose content is readable by a contactless reading device according to a near-field and/or short-range communication protocol such as Bluetooth® or WiFi™. It may also be a non-transient memory of a smart card whose content is readable by a contactless reading device according to a similar communication protocol.

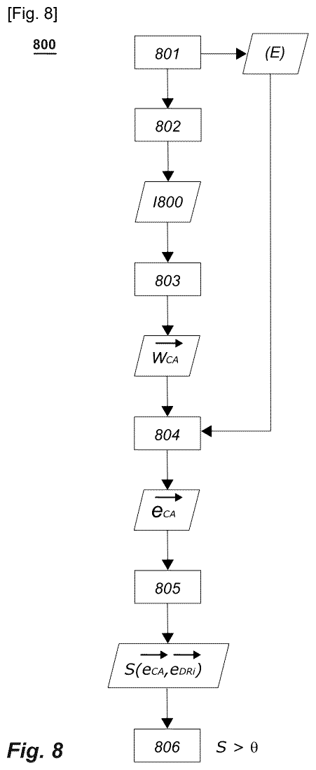

According to a fourth aspect of the invention, referring to FIG. 8, there is provision for a method 800 for biometrically identifying an individual using an encoding matrix (E) obtained using a method 300 according to the first aspect of the invention. The method 800 comprises the following steps:
(a) retrieving 801 an encoding matrix (E) of an individual 103, 507 by reading, preferably contactlessly, a recording medium 605f, 605g, 700;
(b) acquiring 802 a biometric datum relating to said individual 103, 507;
(c) generating 803, from the biometric datum I800, an activation map vector \vec{w}_{CA} by applying a convolutional neural network;
(d) generating 804, from the activation map vector \vec{w}_{CA}, an encoding vector \vec{e}_{CA} by applying the encoding matrix (E);
(e) computing 805 a measure S of similarity between the encoding vector \vec{e}_{CA} and a reference direction \vec{u}_{DRi};
(f) validating 806 the identification of the individual 103, 507 by comparing the value of the measure S of similarity with a previously defined threshold value θ.

The order in which steps 801 to 803 are executed does not matter, provided that step 803 is executed after step 802. For example, steps 802 and 803 can be performed before step 801, or steps 801 and 802 can be performed simultaneously after the execution of step 802.

In step 804, an encoding vector \vec{e}_{CA} is generated by applying the encoding matrix (E) recorded in the recording medium 605f, 605g, 700 to the activation map vector \vec{w}_{CA} generated from the biometric datum. If the biometric datum matches that used to generate the encoding matrix (E) according to a generation method 300 consistent with the first aspect of the invention, then the encoding vector \vec{e}_{CA} represents the reference direction \vec{u}_{DRu}, hereinafter referred to as the “user reference direction”, defined when said encoding matrix (E) is generated.

In step 805, the encoding vector \vec{e}_{CA} is compared with a reference direction \vec{u}_{DRi}, hereinafter referred to as the “identification reference direction”, by computing a measure S of similarity. This identification reference direction \vec{u}_{DRi} is an “expected” reference direction for the encoding matrix (E). It is the reference direction \vec{u}_{DR} that was used to generate the encoding matrix (E) from a biometric datum of the same type for the individual 103, 507. In other words, during identification, application of the encoding matrix (E) to the acquired biometric datum relating to the individual 103, 507 is expected to generate an identical, if not substantially similar, encoding vector \vec{e}_{CA} to the reference direction \vec{u}_{DR} that was used to generate the encoding matrix (E) from a biometric datum of the same type for the individual 103, 507.

In step 806, if the value of the measure S of similarity is greater than a threshold value, the “user reference direction” \vec{u}_{DRu} represented by the encoding vector \vec{e}_{CA} is considered to be identical to the “identification reference direction” \vec{u}_{DRi} and the identification of the individual 103, 507 is validated. Otherwise, the identification of the individual 103, 507 is not validated and they cannot access the resource, the site or the event for which the identification method 800 is carried out.

Failure of an identification can have several origins. For example, the encoding matrix (E) used by the individual 103, 507 to identify themselves has not been generated to allow access to the resource, site or event that they wish to access, especially if the user has not enrolled for this access. In other words, the “user reference direction” \vec{u}_{DRu} defined when the encoding matrix (E) is generated does not match the “identification reference direction” \vec{u}_{DRi} expected during the identification operation. In another example, the biometric datum used to generate the encoding matrix (E) does not match the biometric datum acquired in step 802 during the identification operation. Such a situation can arise when the individual who presents themselves for identification does not match the individual whose biometric datum was used to generate the encoding matrix in an enrolment phase, for example in the case of identity theft by a third party.

Preferably, the activation map vector Wca obtained in step 803 of the identification method 800 according to the fourth aspect of the invention is obtained according to a method similar to that used to generate the activation map vector \vec{v}_{CA} supplied, as input datum, to the method 300 for generating an encoding matrix (E) according to the first aspect of the invention. In particular, the convolution filters and/or neural networks used in the generation method 300 according to the first aspect of the invention and the identification method 800 according to the fourth aspect of the invention are suited so that the features that they encode in the activation maps that they generate from substantially similar biometric data are also similar. Preferably, the convolution filters and/or neural networks are substantially similar between the two methods, or even identical.

The measure S of similarity computed in step 805 is of any type suited to measuring a degree of similarity between two vectors. According to some preferred embodiments, the measure S of similarity is chosen from among a cosine similarity, a Euclidean distance or a Hamming distance. By way of example, a measure S of cosine similarity can be expressed as follows

$$S = \frac{{\vec{e}}_{CA} \cdot {\vec{u}}_{DRi}}{‖ {\vec{e}}_{CA} ‖ ‖ {\vec{u}}_{DRi} ‖} .$$

in step 806, the identification of the individual 103, 507 is then validated when the measure (S of similarity is less than or equal to the value (θ).

According to some preferred embodiments, when the measure (S) of similarity is less than or equal to the threshold value (θ), the method 800 returns a specific character string, and when the measure (S) of similarity is greater than the threshold value (θ), the method 800 returns a random character string. For example, the method 800 may comprise applying a function that returns, on the basis of the measure ((S) of similarity, a specific character string when the encoding vector \vec{e}_{CA} is substantially identical to the reference direction \vec{u}_{DRi}, and a random character string otherwise. The specific character string may be the unit digit or may be derived from the encoding vector \vec{e}_{CA} considered to be a cryptographic key. The identification is then validated according to whether or not the character string is consistent with an expected character string. For example, the expected character string may be a character string that is associated with the individual and stored in a database.

According to some embodiments, when the encoding matrix (E) is an obfuscated encoding matrix (O) as described above within the context of the first aspect of the invention, the identification method 800 comprises, after step 801 and before step 804, a step 804a of computing an encoding matrix (E) by applying a revelation matrix (S⁻¹) to the obfuscated encoding matrix (O), said revelation matrix (S⁻¹) being the inverse matrix of the random invertible obfuscation matrix (S) used to obfuscate said encoding matrix (E).

The revelation matrix (S⁻¹) is a matrix known to the trusted entity whose random invertible obfuscation matrix (S) used to obfuscate said encoding matrix (E) is individual. Preferably, it is known only to said trusted entity. In other words, only the trusted entity is able to apply the matrix by knowing the values of its coefficients or terms and/or the means to implement it. This matrix can optionally be recorded in a memory of a security element.

In a fifth aspect of the invention, referring to FIG. 1, FIG. 2, FIG. 6 & FIG. 7, there is provision for a terminal 101, 200 for biometrically identifying an individual 103, comprising:
a device 201, 206 for acquiring a biometric datum relating to an individual;
a device 105 for reading a recording medium 104, 700, 605f, 605g on which is recorded an encoding matrix (E) obtained using a generation method 300 according to any one of the embodiments of the first aspect of the invention;
a data processing device 202 comprising means for carrying out an identification method 800 according to any one of the embodiments of the fourth aspect of the invention.

A biometric identification terminal according to the fifth aspect of the invention may be used to permit a border crossing for a country, to permit access to one or more remote services, to permit access to information stored in a communal or personal database, to check the identity of one or more persons, to retrieve login credentials, or to retrieve one or more addresses of wallets for digital currency such as cryptocurrency.

### REFERENCES

### Patent Literature

U.S. Pat. No. 4,109,237 A [HILL ROBERT B] Aug. 22, 1978.

WO 9526013 A1 [MINNESOTA MINING & MFG [US]] Sep. 28, 1995.

EP 2 813 961 A1 [KONVALINKA IRA [CA]] Dec. 17, 2014.

WO 2017/019972 A1 [VISA INT SERVICE ASS [US]] Feb. 2, 2017.

### Non-Patent Literature

Dodis et al. (2004), “Fuzzy extractors: How to generate strong keys from biometrics and other noisy data.” Advances In Cryptology-EUROCRYPT 2004: International Conference on the Theory and Applications of Cryptographic Techniques, Interlaken, Proceedings 23.

He, K., Zhang, X., Ren, S., & Sun, J. (2016). Deep residual learning for image recognition. Proceedings of the IEEE conference on computer vision and pattern recognition (pp. 770-778).

Galbraith et al (2019). “Obfuscated fuzzy hamming distance and conjunctions from subset product problems.” Theory of Cryptography Conference.

Dosovitskiy, A. (2020). An image is worth 16×16 words: Transformers for image recognition at scale. arXiv preprint arXiv:2010.11929.

1. A method performed by a data processing device, for generating a biometric encoding matrix (E), the method taking, as input data, a vector, of an activation map of a neural network applied to at least one image of at least one biometric datum relating to an individual, and supplying, as output datum, the encoding matrix (E), the method comprising:
generating, from the activation map, a projection matrix along a reference direction;
generating a rotation matrix that leaves the reference direction invariant; and
computing a composite matrix from the projection matrix and the rotation matrix, the composite matrix being the encoding matrix (E).

2. The method as claimed in claim 1, wherein the rotation matrix is a random matrix.

3. The method as claimed in claim 1, wherein the reference direction is specific to a database for identifying a plurality of individuals and/or to a trusted entity for identifying one or more individuals.

4. The method as claimed in claim 1, wherein the biometric datum relating to the individual can be chosen from among one or more finger and/or palm dactylograms, one or more iris images and/or one or more facial images, or a combination thereof.

5. The method as claimed in claim 1, further comprising:
generating, before the computation step, a random invertible obfuscation matrix (S) specific to a trusted entity for identifying one or more individuals; and
computing, after the computation step, an obfuscated encoding matrix (O)=(S)(E) composed of the random invertible matrix (S) and the encoding matrix (E).

6. A biometric encoding terminal comprising means for performing the method for generating a biometric encoding matrix (E) as claimed in claim 1.

7. A non-transitory recording medium on which is recorded an encoding matrix obtained using the generation method as claimed in claim 1.

8. The medium as claimed in claim 7, wherein the encoding matrix (E) is recorded in a form of a two-dimensional code on the recording medium.

9. The medium as claimed in claim 7, wherein said medium is a non-transient recording medium readable by a data processing device.

10. A method for biometrically identifying an individual using an encoding matrix (E) obtained using the method as claimed in claim 1, the method comprising:
retrieving the encoding matrix (E) of an individual by reading a recording medium;
acquiring a biometric datum relating to said individual;
generating, from the biometric datum, an activation map vector by applying a neural network;
generating, from the activation map vector, an encoding vector by applying the encoding matrix (E);
computing a measure (S) of similarity between the encoding vector and a reference direction; and
validating the identification of the individual by comparing the value of the measure (S) of similarity with a previously defined threshold value.

11. The method as claimed in claim 10 for biometrically identifying an individual using the encoding matrix (E), the method further comprising, after the retrieving step and before the step of generating the encoding vector, a step of computing the encoding matrix (E) by applying a revelation matrix (S⁻¹) to an obfuscated encoding matrix (O), said revelation matrix (S⁻¹) being the inverse matrix of the random invertible obfuscation matrix (S) used to obfuscate said encoding matrix (E).

12. The method as claimed in claim 10, wherein the measure (S) of similarity is a cosine similarity, a Euclidean distance, or a Hamming distance.

13. The method as claimed in claim 10, wherein when the measure (S) of similarity is less than or equal to the threshold value, said method returns a specific character string, and when the measure (S) of similarity is greater than the threshold value, said method returns a random character string.

14. A terminal for biometrically identifying an individual, the terminal comprising:
a device for acquiring configured to acquire a biometric datum relating to an individual;
a device configured to read a recording medium on which is recorded an encoding matrix (E) obtained using a generation method; and
a data processing device comprising means for performing the identification method as claimed in claim 10.
